(19) United States
(12) Patent Application Publication
(10) Pub. No.: US 2018/0121147 A1
(43) Pub. Date: May 3, 2018

(54) INFORMATION PROCESSING APPARATUS, CONTROL METHOD, AND STORAGE MEDIUM

(71) Applicant: CANON KABUSHIKI KAISHA, Tokyo (JP)

(72) Inventors: Yoshiyuki Nagamatsu, Yokohama-shi (JP); Tatsuyuki Yokoyama, Kawasaki-shi (JP)

(21) Appl. No.: 15/798,033

(22) Filed: Oct. 30, 2017

(30) Foreign Application Priority Data
Oct. 31, 2016 (JP) 2016-213531

(51) Int. Cl. G06F 3/12

(52) U.S. Cl. CPC G06F 3/1276; G06F 3/1206; G06F 3/1274; G06F 3/126; G06F 3/1227

(57) ABSTRACT

An information processing apparatus in which a spooler that associates a print job with identification information to manage the print job is operable acquires, from the spooler, the identification information associated with the print job and generates a print command based on the identification information.

### BACKGROUND OF THE INVENTION

### Field of the Invention

The present invention relates to an information processing apparatus, a control method, and a storage medium.

### Description of the Related Art

Printer drivers include a printer driver having a communication control module (hereinafter also referred to as a language monitor) that controls a communication process between an information processing apparatus and a printing apparatus. The printer driver having the language monitor is referred to as a version 3 driver (hereinafter also referred to as a V3 driver). The language monitor receives a print command generated by a command generation filter of the printer driver via an operating system (OS), and transmits the print command to the printing apparatus. Moreover, the language monitor can detect the cancellation of a print process based on the print command in the printing apparatus. If the language monitor has detected the cancellation of the print process based on the print command, a print job corresponding to the print command is deleted from a print queue being an OS configuration module.

On the other hand, a printer driver without a language monitor can run on Windows 8 (trademark), Windows (trademark) RT, and later versions, which have been introduced by Microsoft Corporation. The printer driver with this configuration is referred to as a version 4 printer driver (hereinafter also referred to as a V4 driver).

Japanese Patent Laid-Open No. 2000-81957 describes to delete target print data by using a language monitor if it is instructed to stop printing.

However, Japanese Patent Laid-Open No. 2000-81957 does not consider a situation where there is no language monitor. Hence, if printing is cancelled under an environment without a language monitor, the technology of Japanese Patent Laid-Open No. 2000-81957 may execute a cancellation process that is not desired by a user.

### SUMMARY OF THE INVENTION

Embodiments of the present invention include an information processing apparatus in which a spooler that associates a print job with identification information to manage the print job is operable, the information processing apparatus including: an acquisition unit configured to acquire, from the spooler, the identification information associated with the print job; a transmission unit configured to transmit, to a printing apparatus, a print command based on the print job and the identification information; and a deletion unit configured to, upon having detected cancellation of a print process based on the print command in the printing apparatus, cause the spooler to delete a print job associated with identification information corresponding to information acquired from the printing apparatus, wherein the spooler is provided by an operating system running on the information processing apparatus.

Further features of the present invention will become apparent from the following description of exemplary embodiments with reference to the attached drawings.

### BRIEF DESCRIPTION OF THE DRAWINGS

FIG. 1 is a block diagram illustrating a print system configured including a printing apparatus and an information processing apparatus.

FIG. 2 is a conceptual diagram illustrating the configuration of a V4 printer driver.

FIG. 3 is a block diagram illustrating the configuration of a print system of the present invention in a first embodiment.

FIG. 4 is a diagram illustrating an example of an identifier added to a print job.

FIG. 5 is an example of a screen display of a status management program 331.

FIG. 6 is a flowchart illustrating a process of the printer driver transmitting a print command.

FIG. 7 is a schematic diagram illustrating an overall perspective of a print command generated by the printer driver.

FIG. 8 is a flowchart illustrating a process of deleting a job.

FIG. 9 is a block diagram illustrating the configuration of a print system of the present invention in a second embodiment.

FIG. 10 is a state diagram of a print queue and a printing apparatus in the second embodiment.

FIG. 11 is a flowchart illustrating a process of deleting a job in progress.

### DESCRIPTION OF THE EMBODIMENTS

Embodiments of the present invention are described in detail hereinafter with reference to the accompanying drawings. The following embodiments do not limit the present invention according to the claims. Moreover, not all combinations of features described in the embodiments are necessarily required by the solving means of the present invention.

### First Embodiment

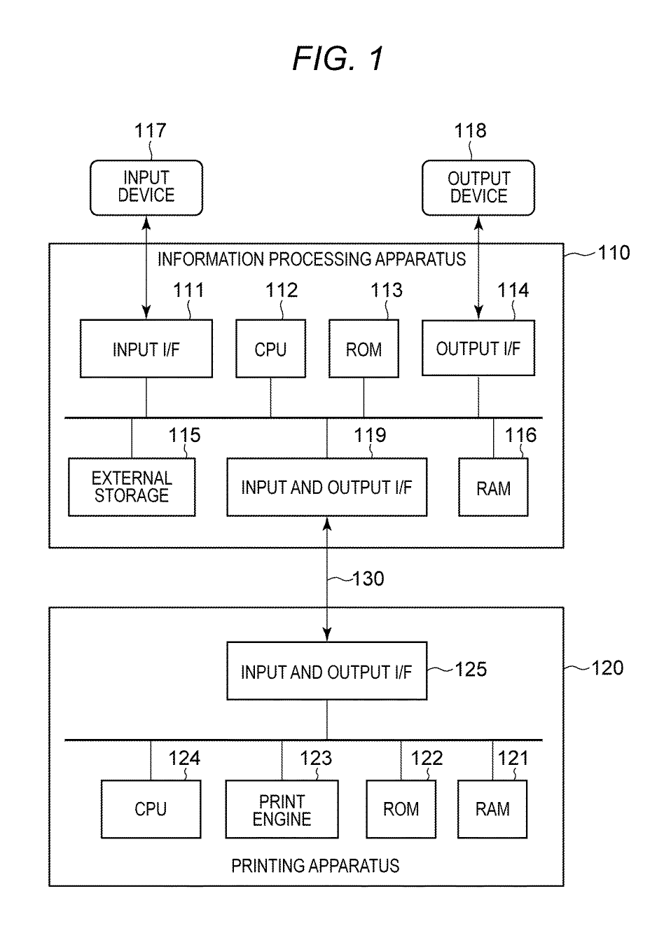

FIG. 1 is an example of a block diagram illustrating the entire configuration of a print system including an information processing apparatus 110 and a printing apparatus 120 that is connectable to the information processing apparatus 110. The information processing apparatus 110 includes an input I/F 111, a CPU 112, a ROM 113, an output I/F 114, an external storage 115, a RAM 116, an input device 117, an output device 118, and an input and output I/F 119. The ROM 113 saves an initialization program. An OS, a printer driver, and other various types of data are saved in the external storage 115. Various programs saved in the external storage 115 use the RAM 116 as work memory. The input device 117 is used to input data and instruct an operation, and connected to the input I/F 111. The output device 118 is used to display data and notify a state, and is connected to the output I/F 114. In the embodiment, the CPU 112, the ROM 113, the RAM 116, and the like form a computer.

The printing apparatus 120 is configured including a RAM 121, a ROM 122, a print engine 123, a CPU 124, and an input and output I/F 125. The information processing apparatus 110 and the printing apparatus 120 are connected by a USB (trademark) cable 130. The connection mode may be another connection mode, and may be, for example, wireless connection. The RAM 121 is used as work memory of the CPU 124, and also used as a buffer for temporarily saving received data. The ROM 122 saves a control command. The print engine 123 prints on the basis of a print command transmitted from the information processing apparatus 110. The CPU 124 controls the printing apparatus 120 in accordance with the control command saved in the ROM 122. In the embodiment, a sharing of processes between the information processing apparatus 110 and the printing apparatus 120 is illustrated as described above. However, the process-sharing form may vary.

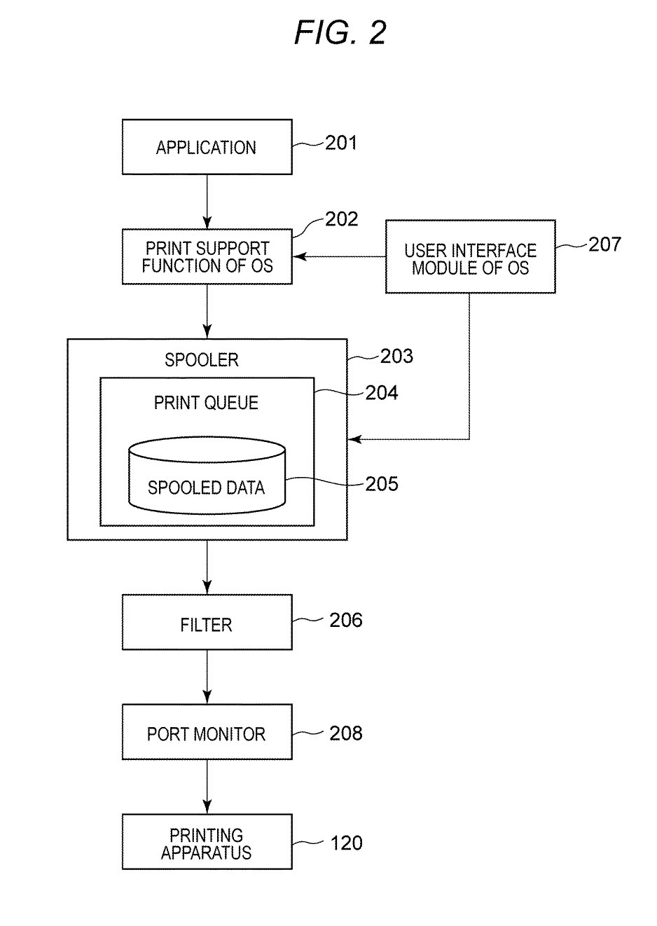

FIG. 2 is an example of a diagram conceptually representing the configuration of a V4 print system including a V4 printer driver in the embodiment. The V4 print system of FIG. 2 is configured in the information processing apparatus 110. As described above, the V4 printer driver does not include a language monitor that executes bidirectional communication with the printing apparatus. In other words, a print architecture configured in the information processing apparatus restricts that the printer driver includes the language monitor that executes bidirectional communication with the printing apparatus. Print data created by an application 201 is temporarily accumulated in a print queue 204 of a spooler 203 as spooled data 205 via a print support function 202 of the OS. The spooled data 205 is also called a print job. The accumulated spooled data 205 is converted by a command generation filter 206 being one of filters configuring the V4 printer driver into a print command that can be interpreted by the printing apparatus 120, and then transmitted to the printing apparatus 120. The application 201 adds print setting information returned from a user interface module 207 of the OS, to print data via the print support function 202 of the OS, when instructing printing. The print setting information is information set prior to an instruction of the application 201 to start printing. The command generation filter 206 converts the received print data in accordance with the print setting information added to the print data to generate a print command that can be interpreted by the printing apparatus 120. The command generation filter 206 then transmits the generated print command to the printing apparatus 120 via the spooler 203 and a USB port monitor 208. When having detected that the process of transmitting the print command corresponding to the print job is complete, the spooler 203 deletes the print job from the print queue.

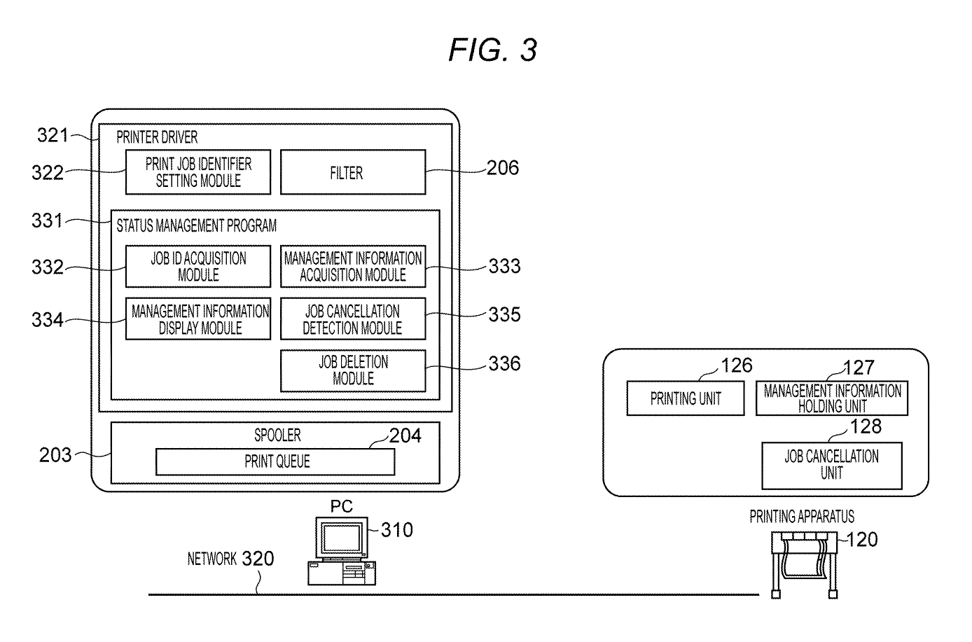

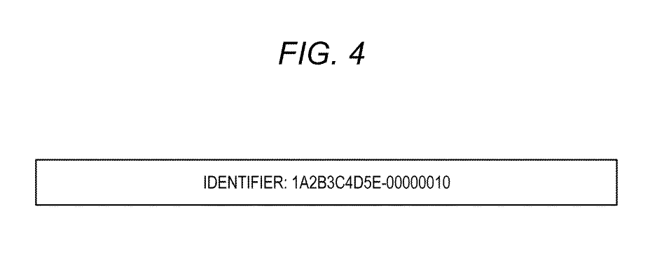

FIG. 3 is a block diagram illustrating the configuration of a print system in the first embodiment of the present invention, and includes a PC 310, a network 320, and the printing apparatus 120. The PC 310 corresponds to the above-mentioned information processing apparatus 110. The PC 310 is provided with a printer driver 321, a print job identifier setting module 322, a status management program 331, the spooler 203 being the configuration module of the OS, and the print queue 204. The printer driver 321 transmits a print command to the printing apparatus 120 to cause the printing apparatus 120 to execute a print process based on the print command. Moreover, the printer driver 321 acquires the status (status) of the printing apparatus 120 and provides a user with information related to the printing apparatus, as another process. The print job identifier setting module 322 adds an identifier to the print command issued by the printer driver 321. FIG. 4 illustrates an example of an identifier added to a print command, the identifier being set in the print job identifier setting module 322. The identifier illustrated in FIG. 4 is represented by numerical values, a hyphen, and alphabets. However, the configuration of the identifier is not limited to this example.

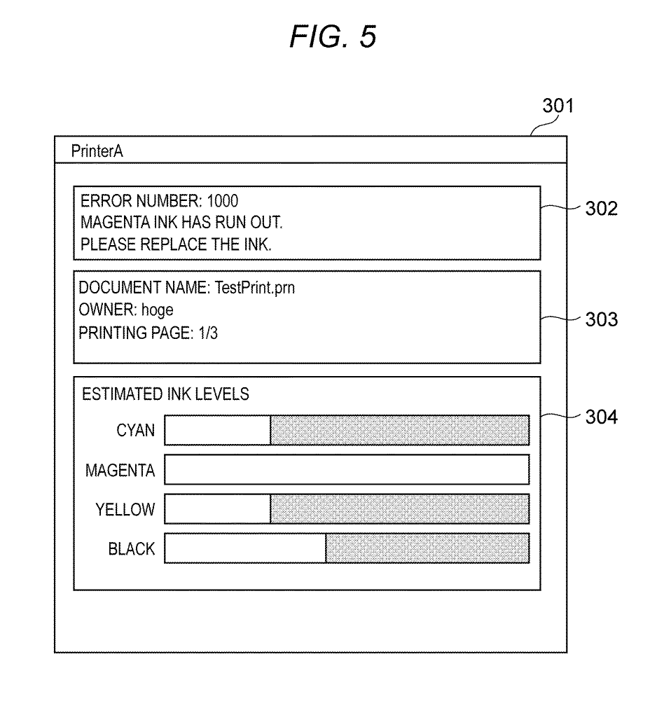

Returning to FIG. 3, the printing apparatus 120 is provided with a printing unit 126 for controlling the printing operation, a management information holding unit 127 that holds the status of the printing apparatus 120, and a job cancellation unit 128 for cancelling a print command. The status management program 331 includes a job ID acquisition module 332, a management information acquisition module 333, a management information display module 334, a job cancellation detection module 335, and a job deletion module 336. The status management program 331 is registered as a startup program, and starts automatically at startup of the OS to operate as a resident program. The job ID acquisition module 332 acquires a job ID from the spooler 203. The job ID is issued by the spooler 203. The management information acquisition module 333 accesses the printing apparatus 120, and acquires status information of the printing apparatus 120 from the management information holding unit 127. The management information display module 334 displays information necessary for the user on a UI on the basis of the status information acquired by the management information acquisition module 333. FIG. 5 is an example of a UI display by the status management program 331. A title bar 301 displays, for example, the name of an application or the printing apparatus. A message display section 302 informs the user of the state of the printing apparatus 120 on the basis of the information acquired by the management information acquisition module 333. A job information display section 303 displays the progress state of the printing operation on the basis of the information acquired by the management information acquisition module 333. An ink information display section 304 displays the consumption state of ink used by the printing apparatus 120 on the basis of the information acquired by the management information acquisition module 333. The user can grasp the progress state of a print command, check the time when to replace ink and the type of ink, and recognize the occurrence or non-occurrence of an error, by checking such information. Such information is especially useful during the operation of the printing apparatus.

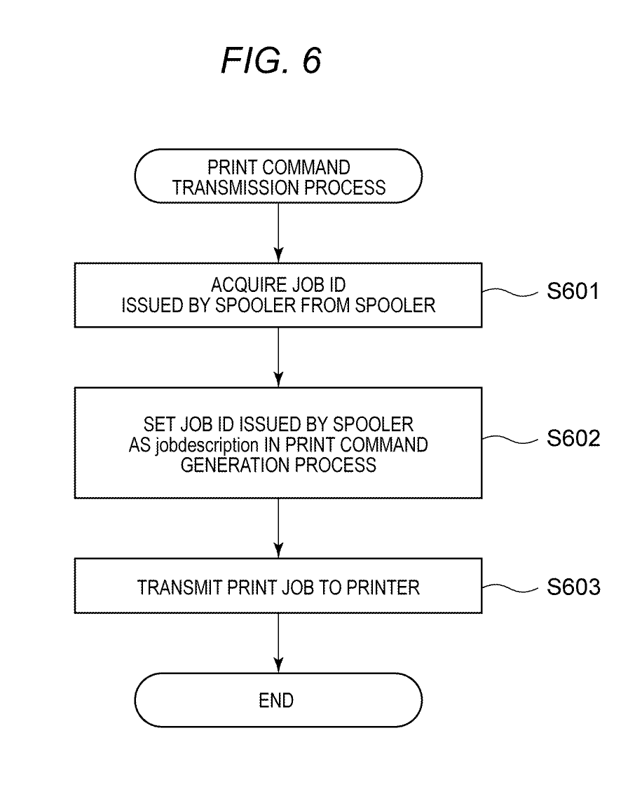

Returning to FIG. 3, the job cancellation detection module 335 analyzes status information acquired by the management information acquisition module 333 from the printing apparatus 120, and detects whether or not the job cancellation unit 128 has cancelled a job. When the job cancellation detection module 335 has detected the cancellation of a print process, the job deletion module 336 checks whether or not a print job corresponding to the print process cancelled in the printing apparatus 120 is in the print queue 204. If the print job corresponding to the cancelled print process is in the print queue 204, the job deletion module 336 instructs the spooler to delete the print job from the print queue. FIG. 6 is a flowchart illustrating the process of the printer driver 321 transmitting a print command to the printing apparatus 120. The flowchart of the present application is executed by the CPU 112 reading and executing a program related to the flowchart.

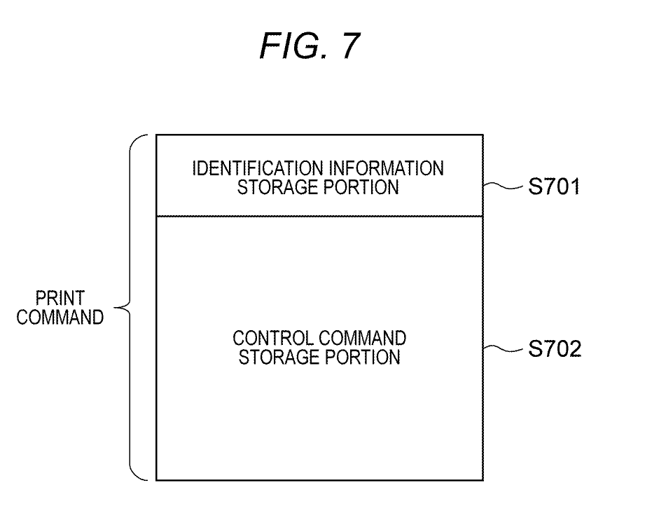

When printing is instructed in the application, the spooler 203 manages a print job using the print queue 204. When managing a print job using the print queue 204, the spooler 203 issues a job ID associated with the print job. The job ID acquisition module 332 acquires the job ID issued by the spooler 203 (S601). In the following S602, the print job identifier setting module 322 sets, in a print command, a job identifier, corresponding to the job ID, for uniquely identifying a print job. FIG. 7 is a schematic diagram illustrating an overall perspective of a print command generated by the printer driver 321. The print command generated by the printer driver 321 includes an identification information storage portion 701 and a control command storage portion 702. The job identifier set in S602 is stored in the identification information storage portion 701. A command to control the operation of the printing apparatus 120 is stored in the control command storage portion. The job identifier may be the job ID itself issued by the spooler 203, the job ID having been acquired in S602. Alternatively, the job identifier may be a combination of the job ID and other information, for example, a Globally Unique Identifier (hereinafter also referred to as a GUID) as illustrated in FIG. 4 to avoid an overlap of a job issued from another PC. In the following S603, the printer driver 321 executes the process of transmitting the print command to the printing apparatus 120 to end this process.

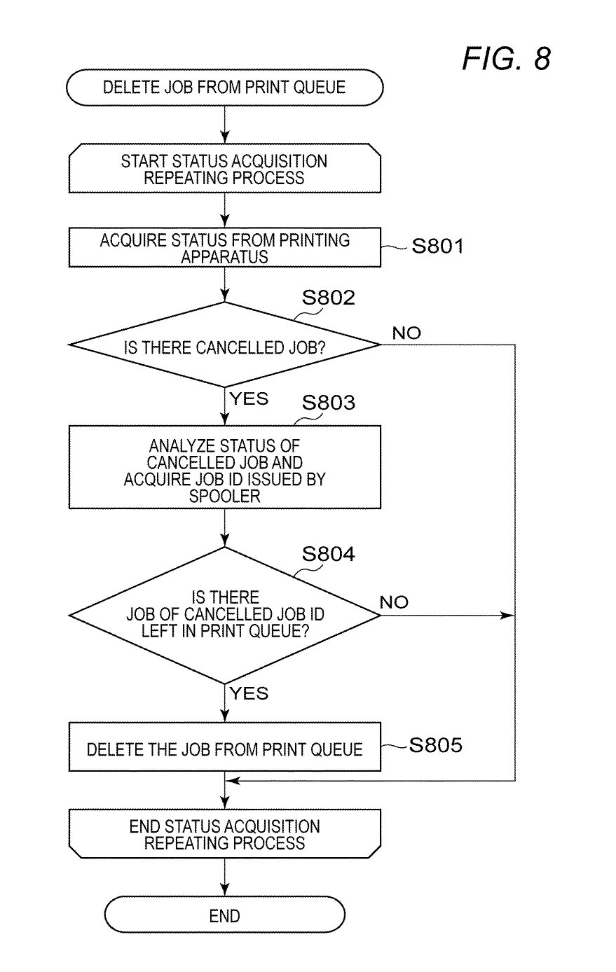

FIG. 8 is a flowchart for explaining a process of the printer driver 321 when a print process corresponding to a print command has been cancelled in the printing apparatus 120. In the embodiment, the printing apparatus 120 manages the received print command as a print execution job.

The management information acquisition module 333 accesses the printing apparatus 120 in S801, and acquires the status information of the printing apparatus 120. Furthermore, in S802, the job cancellation detection module 335 analyzes the acquired status information, and determines whether or not the job cancellation unit 128 of the printing apparatus 120 has cancelled a print process based on a print command. If the print process based on the print command has not been cancelled, the process ends. If it has been determined that the print process based on the print command was cancelled, in S803 the job deletion module 336 acquires a job identifier included in the status information acquired in S801. If, for example, a print process of a print command where “111” is set as a job identifier has been cancelled, the management information acquisition module 333 acquires, from the printing apparatus 120, the status information indicating that the print process corresponding to the job identifier “111” has been cancelled. In other words, the status information acquired in S801 includes a job identifier. The job deletion module 336 checks whether or not a print job associated with identification information corresponding to the job identifier acquired in S803 is in the print queue 204 (S804). If there is not the print job associated with the identification information corresponding to the job identifier, the process ends. If the print job associated with the identification information corresponding to the job identifier is in the print queue 204, the job deletion module 336 instructs the spooler 203 to delete the print job from the print queue 204 in S805.

The example where the job cancellation unit 128 cancels a print process is illustrated above. However, the printing apparatus 120 may be turned off to make a cancelation. If the printing apparatus 120 is turned off halfway through the print process, a print execution job in progress is cancelled. Accordingly, a print job corresponding to the cancelled print execution job is also deleted from the print queue 204. In addition, the print execution job may be cancelled by remotely operating the printing apparatus 120 from the information processing apparatus or a mobile terminal.

According to the embodiment described above, a print command is generated on the basis of a job identifier corresponding to a job ID issued by the spooler. This process allows a print process cancelled in the printing apparatus 210 and a print job present in the print queue 204 to be tied to each other. As a result, if the print process is cancelled in the printing apparatus 210, the print job related to the print process can be appropriately deleted from the print queue 204.

For example, it is also conceivable that between when the process of transmitting a print command corresponding to a print job 1 is complete and when a print process corresponding to the print command is complete in the printing apparatus 120, the print process is cancelled in the printing apparatus 120. The spooler 203 deletes the print job 1 from the print queue 204 at the time when the process of transmitting the print job is complete. Consequently, only a print job 2 is managed in the print queue. Even if the status management program 331 detects the cancellation of the print process of the print command corresponding to the print job 1 as described above in this state, the status information acquired from the printing apparatus 120 includes an identifier corresponding to the print job 1. Hence, the identifier corresponding to the print job 1 does not correspond to identification information of the print job 2 managed in the print queue. Accordingly, it is possible to reduce the possibility that the print job 2 is wrongly deleted from the print queue and therefore a deletion process that is not intended by a user is performed.

Moreover, for example, a case is assumed in which the print jobs 1 and 2 are managed by the spooler 203. In this case, if the embodiment is not implemented when the print command corresponding to the print job 1 is transmitted to the printing apparatus 120 and then cancelled in the printing apparatus 120, the print command corresponding to the print job 1 results in being unnecessarily transmitted to the printing apparatus even after the cancellation. Moreover, the process for the print job 2 does not start until the process of transmitting the print command corresponding to the print job 1 is complete. On the other hand, the embodiment also enables the solution of such a point.

### Second Embodiment

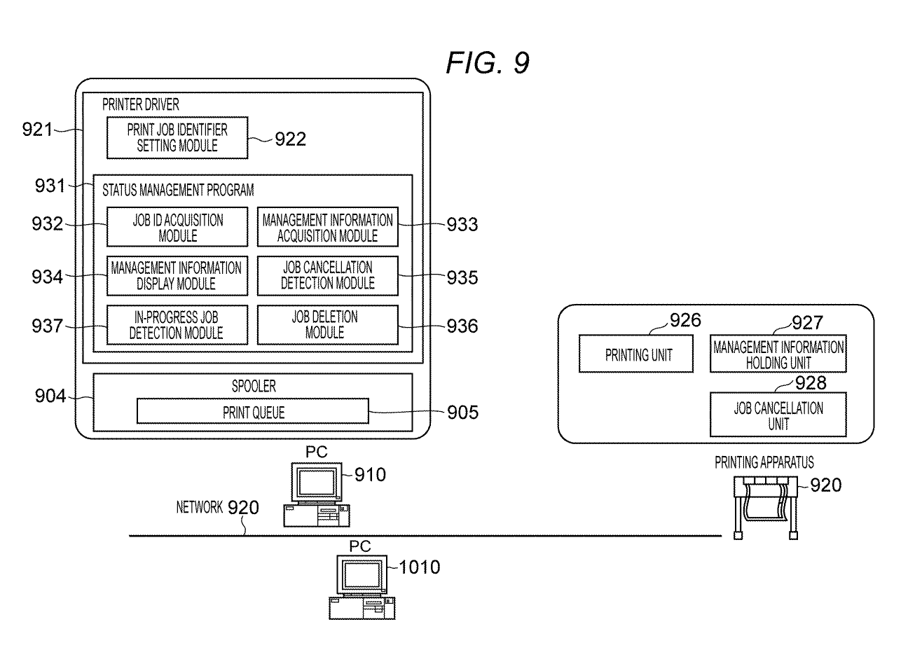

FIG. 9 is a diagram illustrating a network environment in the embodiment. The points different from the first embodiment are that a plurality of PCs is connected on a network and that the status management program 931 includes an in-progress job detection module 937. Also in the embodiment, it is assumed to use the information processing apparatus 110 and the printing apparatus 120, which are described in FIG. 1. Moreover, a description of the same processes as those of the first embodiment is omitted.

In the first embodiment, a print job is deleted from a print queue by using a job ID issued by the spooler, the job ID having been acquired in S803 of FIG. 8. In the embodiment, a process that is not described in the first embodiment is executed to achieve the process of deleting the print job in consonance with a user's intention.

A printing apparatus of the second embodiment may support a function of enabling a reservation for the printing order by receiving a part of a print command even during processing of another print command and making the print command reserved. This function is referred to as multi-session job queuing.

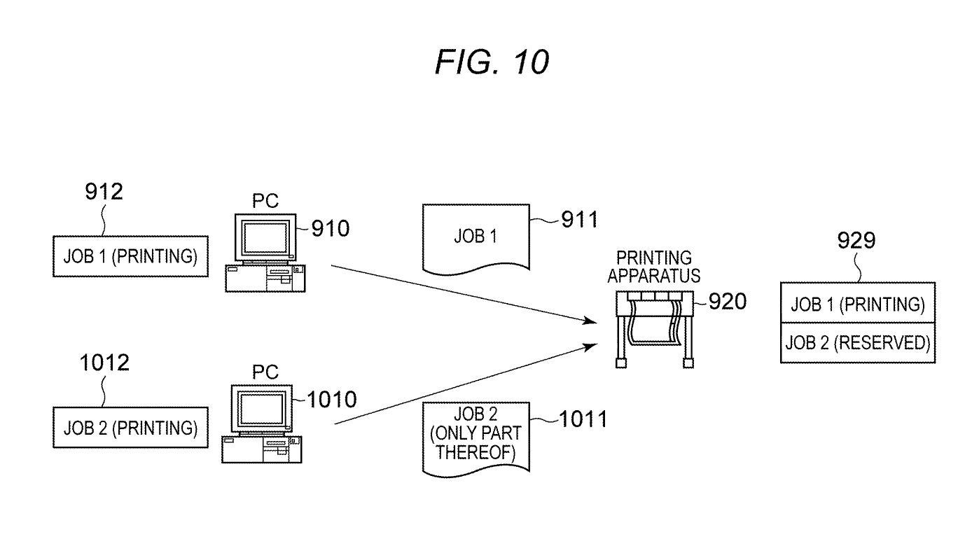

FIG. 10 is a diagram illustrating the state of a printing apparatus 920 that supports multi-session job queuing and the states of print queues of PCs 910 and 1010 when the PCs 910 and 1010 issue print commands to the printing apparatus 920. The printing apparatus 920 receives the print command issued from the PC 910 and manages the print command as a print execution job 911. The print execution job 911 is a print process target. The printing apparatus 920 then receives a part of the print command from the PC 1010 and manages the part of the print command as a print execution job 1011 in a queue 929 of the printing apparatus 920. Specifically, a Start job command being the part of the print command is stored as the print execution job in the queue of the printing apparatus. The Start job command includes, for example, the name of a computer of the information processing apparatus of the transmission source. If the printing apparatus 920 is turned off here, the printing apparatus 920 performs the cancellation process on the print execution jobs 1 and 2 stored in its own queue 929. At this point in time, the status information that can be acquired by a management information acquisition module 933 in FIG. 9 includes information indicating that the print execution job 1 in progress has been cancelled, and information indicating that the printing apparatus 920 has been turned off. The status information does not include information that the print execution job 2 in a process waiting state has been cancelled. The management information acquisition module 933 acquires the status information and accordingly a job cancellation detection module 935 of the PC 910 in FIG. 9 detects the cancellation of the print execution job 1. The process illustrated in the first embodiment allows a job deletion module 936 to delete, from the print queue 912, the print job 1 corresponding to the print execution job 1 cancelled in the printing apparatus 920 if the print job 1 is in the print queue 912. In the PC 1010, the status information acquired by the management information acquisition module 933 does not, however, include information related to the print command issued by the PC 1010 itself. Hence, the print job corresponding to the print command that has been transmitted until some midpoint cannot be deleted from a print queue 1012.

In the embodiment, an in-progress job detection module 937 is provided to process a print job corresponding to a print execution job reserved by such multi-session job queuing. If a print job in progress is in a print queue, the print job is deleted by using the in-progress job detection module 937.

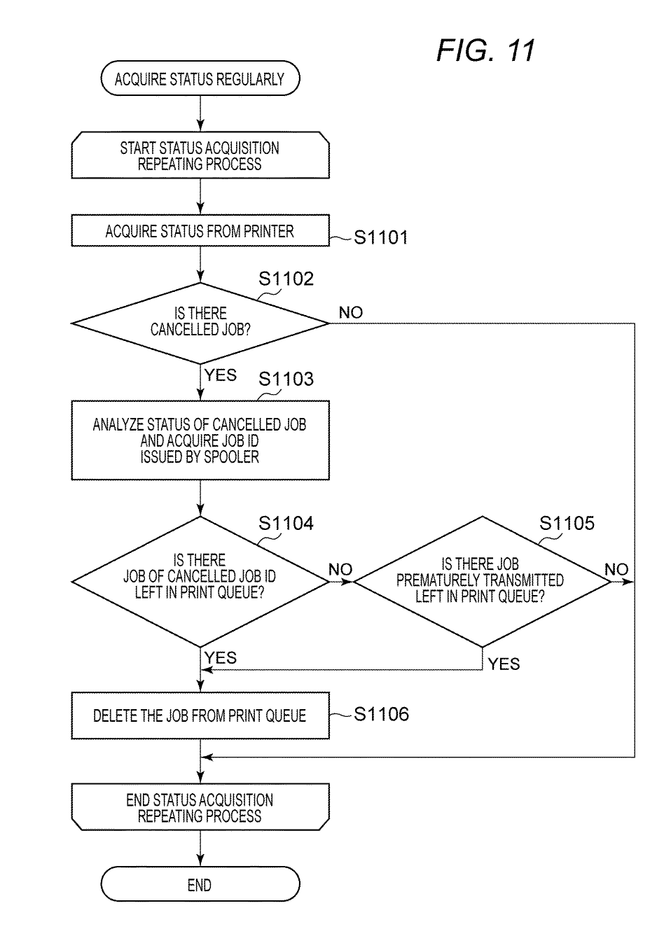

FIG. 11 is a flowchart illustrating a job deletion process to be executed by the CPU 112 of the PC 1010 in the embodiment. When this process is started, the management information acquisition module 933 acquires status information from the printing apparatus 920 in S1101. Furthermore, in S1102, the job cancellation detection module 935 analyzes the status information acquired above and determines whether or not that a job has been cancelled. If having detected, from the status information, that a job has been cancelled by a job cancellation unit 928, the job cancellation detection module 935 determines Yes in S1102. In addition, if having detected, from the status information, that the printing apparatus 920 has been turned off, the job cancellation detection module 935 determines Yes in S1102.

If a print process has not been cancelled, the process ends. If a print process has been cancelled, the job deletion module 936 acquires a job identifier from the status information in S1103. Furthermore, the job deletion module 936 checks whether or not a print job of identification information corresponding to the job identifier acquired in S1103 is in a print queue 905 (S1104). If the print job of the identification information corresponding to the acquired job identifier is in the print queue 905, the job deletion module 936 instructs a spooler 904 in S1106 to delete the print job from the print queue 905. If the print job of the identification information corresponding to the acquired job identifier is not in the print queue 905, the process of FIG. 11 proceeds to S1105. The in-progress job detection module 937 checks whether or not a print job whose print command has been partially transmitted to the printing apparatus 920 by multi-session job queuing is in the print queue 905 (S1105). Specifically, the in-progress job detection module 937 determines whether or not print jobs in the print queue 905 include a print job with a status indicating “printing”. If there is no print job whose print command has been partially transmitted to the printing apparatus 920, the process ends. If a print job whose print command has been partially transmitted to the printing apparatus 920 is identified, the job deletion module 936 instructs the spooler 904 in S1106 to delete the print job from the print queue 905. The example where the status of a print job in a print queue is used is illustrated above as the method for determining whether or not a part of a print command has been transmitted. However, the present invention is not limited to this example. For example, the determination may be made on the basis of the presence or absence of a flag indicating to be a print job for which multi-session job queuing has been used.

As described above, according to the embodiment, even if the printing apparatus that supports multi-session job queuing is turned off, it is possible to appropriately delete a print job from a print queue in each PC being a job issuer. As a result, it becomes possible to avoid a problem that a print job that needs to be deleted remains in a print queue and accordingly a printing start process for the next print job is delayed. Moreover, it is possible to reduce the possibility that in a situation where there is a print job whose print command has been partially transmitted left in a print queue, an error occurs in the printing apparatus due to the transmission of the print command corresponding to the print job to the printing apparatus.

### Other Embodiments

As other embodiments, the execution or non-execution of the process of setting an identifier for uniquely identifying a print job and the process of deleting a print job corresponding to a print execution job cancelled in the printing apparatus from a print queue may be switched according to the communication port used. In other words, if a USB port or WSD port is used, it is possible to leave a print job in a print queue until completion of a print process in the printing apparatus. It is also possible to not execute the above processes if such a port is used, and to execute the above processes only if a Standard TCP/IP port is used. In other words, if a USB port or WSD port is used, the information processing apparatus is simply required to delete a print job managed at the top of a print queue in response to detection that a print process has been cancelled in the printing apparatus. On the other hand, if the Standard TCP/IP port is used, a print job 1 corresponding to a print command 1 is deleted from the print queue at the point in time when the information processing apparatus completes the transmission of the print command 1 to the printing apparatus. Hence, if the above-mentioned processes are not executed, the print job managed at the top of the print queue is changed to the next print job 2 at the point in time when the transmission of the print command 1 is complete. If, in this state, the information processing apparatus detects that the job corresponding to the print command 1 has been cancelled in the printing apparatus and deletes the print job 2 managed at the top of the print queue, the deletion process that is not intended by a user results in being executed. Hence, if the Standard TCP/IP port is used, the above-mentioned processes are executed to enable the execution of the deletion process intended by the user. If in this manner the process is switched according to the port, the information processing apparatus includes a port determination module that determines a port used for printing. If the port determination module determines that the port used is the USB port or WSD port, the processes of FIGS. 8 and 11 are not executed. On the other hand, if the port determination module determines that the port used is a predetermined port, the process of FIG. 8 or 11 is executed. If a predetermined port (for example, the Standard TCP/IP port) is used, a print job corresponding to a print command is deleted from a print queue at the point in time when the process of transmitting the print command to the printing apparatus is complete.

Furthermore, the job deletion module 336 (936) determines whether or not its own PC has issued a print command corresponding to a print process cancelled in the printing apparatus before deleting a print job from a print queue. Only if it is the print process corresponding to the print command issued by the own PC, the job deletion module 336 (936) may instruct the spooler to delete the print job from the print queue.

Moreover, in FIGS. 3 and 9, the status management program 331 (931) is illustrated as a constituent of the printer driver 321 (921). It may be configured, however, that the status management program 331 (931) is made as a separate module independent of the printer driver and works in cooperation with the printer driver.

Moreover, in the above-mentioned embodiments, it has been described that status information does not include information indicating that a print execution job in the process waiting state has been cancelled in the printing apparatus. However, the printing apparatus may generate status information including the information indicating that a print execution job in the process waiting state has been cancelled. In this case, the management information acquisition module 933 may analyze status information acquired from the printing apparatus to delete, from a print queue, a print job corresponding to the print execution job in the state of waiting to be printed in the printing apparatus.

Furthermore, embodiments of the present invention are realized by executing the following process, that is, a process of supplying software (a program) that achieves the functions of the above-mentioned embodiments to a system or apparatus via a network or various storage media, and causing a computer (or CPU, MPU, or the like) of the system or apparatus to read and execute the program. Moreover, the program may be executed by one computer, or executed in an interlocked fashion by a plurality of computers. Moreover, not all of the above processes need to be achieved by software. Part or all of the processes may be achieved by hardware such as an ASIC. Moreover, also in terms of the CPU, it is not limited to that one CPU performs all the processes. A plurality of CPUs may perform the processes in cooperation where appropriate.

According to embodiments of the present invention, it becomes possible to reduce the risk that a cancellation process that is not desired by a user is executed.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2016-213531, filed Oct. 31, 2016, which is hereby incorporated by reference herein in its entirety.

What is claimed is:

1. An information processing apparatus in which a spooler that associates a print job with identification information to manage the print job is operable, the information processing apparatus comprising:
an acquisition unit configured to acquire, from the spooler, the identification information associated with the print job;
a transmission unit configured to transmit, to a printing apparatus, a print command based on the print job and the identification information; and
a deletion unit configured to, upon having detected cancellation of a print process based on the print command in the printing apparatus, cause the spooler to delete a print job associated with identification information corresponding to information acquired from the printing apparatus,
wherein the spooler is provided by an operating system running on the information processing apparatus.

2. The information processing apparatus according to claim 1, wherein the print command is generated on the basis of the identification information acquired from the spooler or predetermined identification information acquired from the spooler.

3. The information processing apparatus according to claim 1, wherein upon the identification information included in the information acquired from the printing apparatus having been determined to correspond to the identification information associated with the print job managed by the spooler, the print job is deleted by the spooler.

4. The information processing apparatus according to claim 1, further comprising an identification unit configured to, upon it having been determined that the print job associated with the identification information corresponding to the information acquired from the printing apparatus is not managed by the spooler, identify a print job whose status is printing among print jobs managed by the spooler, wherein the identified print job is deleted by the spooler.

5. The information processing apparatus according to claim 1, further comprising a port determination unit configured to determine whether or not a port used to transmit the print command is a predetermined port,
wherein upon it having been determined that the port used is the predetermined port, and it having been detected that the print process based on the print command was cancelled in the printing apparatus, the print job associated with the identification information corresponding to the information acquired from the printing apparatus is deleted by the spooler, and
upon the predetermined port having been used and a process of transmitting the print command having been completed, the spooler deletes the print job corresponding to the print command for which the transmission process was completed.

6. The information processing apparatus according to claim 1, wherein inclusion of a language monitor that executes bidirectional communication with the printing apparatus in a printer driver is restricted.

7. The information processing apparatus according to claim 6, wherein the printer driver is a version 4 printer driver.

8. A control method to be executed in an information processing apparatus in which a spooler that associates a print job with identification information to manage the print job is operable, the control method comprising:
acquiring, from the spooler, the identification information associated with the print job;
transmitting, to a printing apparatus, a print command based on the print job and the identification information; and
upon having detected cancellation of a print process based on the print command in the printing apparatus, causing the spooler to delete a print job associated with identification information corresponding to information acquired from the printing apparatus,
wherein the spooler is provided by an operating system running on the information processing apparatus.

9. The control method according to claim 8, wherein the print command is generated on the basis of the identification information acquired from the spooler or predetermined identification information acquired from the spooler.

10. The control method according to claim 8, wherein upon the identification information included in the information acquired from the printing apparatus having been determined to correspond to the identification information associated with the print job managed by the spooler, the print job is deleted by the spooler.

11. The control method according to claim 8, further comprising, upon it having been determined that the print job associated with the identification information corresponding to the information acquired from the printing apparatus is not managed by the spooler, identifying a print job whose status is printing among print jobs managed by the spooler, wherein the identified print job is deleted by the spooler.

12. The control method according to claim 8, further comprising determining whether or not a port used to transmit the print command is a predetermined port,
wherein upon it having been determined that the port used is the predetermined port, and it having been detected that the print process based on the print command was cancelled in the printing apparatus, the print job associated with the identification information corresponding to the information acquired from the printing apparatus is deleted by the spooler, and
upon the predetermined port having been used and a process of transmitting the print command having been completed, the spooler deletes the print job corresponding to the print command for which the transmission process was completed.

13. The control method according to claim 8, wherein inclusion of a language monitor that executes bidirectional communication with the printing apparatus in a printer driver is restricted.

14. The control method according to claim 8, wherein the printer driver is a version 4 printer driver.

15. A computer-readable storage medium storing a program including instructions, which when executed by a computer of an information processing apparatus in which a spooler that associates a print job with identification information to manage the print job is operable, cause the information processing apparatus to perform a control method comprising:
acquiring, from the spooler, the identification information associated with the print job;
transmitting, to a printing apparatus, a print command based on the print job and the identification information; and
upon having detected cancellation of a print process based on the print command in the printing apparatus, causing the spooler to delete a print job associated with identification information corresponding to information acquired from the printing apparatus,
wherein the spooler is provided by an operating system running on the information processing apparatus.

16. The storage medium according to claim 15, wherein the print command is generated on the basis of the identification information acquired from the spooler or predetermined identification information acquired from the spooler.

17. The storage medium according to claim 15, wherein upon the identification information included in the information acquired from the printing apparatus having been determined to correspond to the identification information associated with the print job managed by the spooler, the print job is deleted by the spooler.

18. The storage medium according to claim 15, the control method further comprising, upon it having been determined that the print job associated with the identification information corresponding to the information acquired from the printing apparatus is not managed by the spooler, identifying a print job whose status is printing among print jobs managed by the spooler,
wherein the identified print job is deleted by the spooler.

19. The storage medium according to claim 15, the control method further comprising determining whether or not a port used to transmit the print command is a predetermined port,
wherein upon it having been determined that the port used is the predetermined port, and it having been detected that the print process based on the print command was cancelled in the printing apparatus, the print job associated with the identification information corresponding to the information acquired from the printing apparatus is deleted by the spooler, and
upon the predetermined port having been used and a process of transmitting the print command having been completed, the spooler deletes the print job corresponding to the print command for which the transmission process was completed.

20. The storage medium according to claim 15, wherein inclusion of a language monitor that executes bidirectional communication with the printing apparatus is restricted.
